(19) United States
(12) Patent Application Publication
(10) Pub. No.: US 2013/0209286 A1
(43) Pub. Date: Aug. 15, 2013

(54) HYDROGEN PUMP SYSTEM OPERABLE WITHOUT EXTERNAL ELECTRIC POWER SUPPLY

(71) Applicant: KOREA INSTITUTE OF SCIENCE AND TECHNOLOGY, (US)

(72) Inventors: Jong Hyun JANG, Seoul (KR); Soo Jin KIM, Seoul (KR); Hyoung-Juhn KIM, Gyeonggi-do (KR); Eun Ae CHO, Seoul (KR); Dirk HENKENSMEIER, Seoul (KR); Suk Woo NAM, Seoul (KR); Tae-Hoon LIM, Seoul (KR); Jonghee HAN, Seoul (KR); Sung Pil YOON, Gyeonggi-do (KR)

(73) Assignee: KOREA INSTITUTE OF SCIENCE AND TECHNOLOGY, Seoul (KR)

(21) Appl. No.: 13/657,457

(22) Filed: Oct. 22, 2012

(30) Foreign Application Priority Data
Feb. 15, 2012 (KR) 10-2012-0015092

(51) Int. Cl. F04D 13/02; H01M 8/02

(52) U.S. Cl. 417/313

(57) ABSTRACT

Disclosed is a hydrogen pump system operable without external electric power supply. The hydrogen pump system is capable of separating or purifying hydrogen without an external electric power supply.

### CROSS-REFERENCE TO RELATED APPLICATIONS

This application claims priority under 35 U.S.C. §119 to Korean Patent Application No.10-2012-0015092 filed on Feb. 15, 2012, in the Korean Intellectual Property Office, the disclosure of which is incorporated herein by reference in its entirety.

### TECHNICAL FIELD

The present disclosure relates to a hydrogen pump system operable without external electric power supply.

### BACKGROUND

Effective separation or purification of hydrogen is a prerequisite for the development of hydrogen economy. That is to say, for hydrogen to be applicable as energy source in various fields, the hydrogen purification technique should be more advanced.

Hydrogen is an important reactant or byproduct used in various industrial processes including, for example, ammonia production, oil refining, methanol production, hydrogenation, and so forth. For example, in many processes, to remove hydrogen from a gas mixture containing CO₂ for concentration and removal of CO₂, to increase the ratio of H₂/(CO+CO₂) from a mixture gas produced as reaction product or byproduct of carbon-based fuels, or to control the ratio of H₂/N₂ during ammonia production is very important in utilization of hydrogen as energy source.

For purification of hydrogen, electrochemical hydrogen pumping using a proton exchange membrane (PEM) is disclosed in, for example, U.S. Pat. No. 3,489,670. However, the existing technique is restricted in that external power supply is necessary for operation.

### SUMMARY

The present disclosure is directed to providing a hydrogen pump system operable without external electric power supply, which is capable of separating or purifying hydrogen without external electric power supply.

In an aspect, the present disclosure provides a hydrogen pump system operable without external electric power supply, comprising (i) m hydrogen pumps comprising (a₁) a first hydrogen pump, . . . , and (aₘ) an m-th hydrogen pump and (ii) n fuel cells comprising (b₁) a first fuel cell, . . . , and (bₙ) an n-th fuel cell.

In accordance with the various embodiments of the present disclosure, various types of hydrogen pump systems operable without external electric power supply capable of separating or purifying hydrogen without an external electric power supply are provided.

### BRIEF DESCRIPTION OF THE DRAWINGS

FIG. 1 schematically shows an existing hydrogen pump system.

FIG. 2 schematically shows a hydrogen pump system operable without external electric power supply according to an exemplary embodiment of present disclosure.

FIG. 3 schematically shows an inner structure of a hydrogen pump system operable without external electric power supply according to an exemplary embodiment of present disclosure. In FIG. 3, an external cable connecting the leftmost hydrogen pump of the stack to the rightmost fuel cell of the stack is not shown. A resistor (Vᵣ) for maintaining temperature, an additional power supply (Vₑₓₜ), an ammeter, etc. may be connected to the external cable.

FIGS. 4a and 4b show the performance of an MEA using a PBI membrane (H₂+CO₂ mixture gas, 160° C.).

FIGS. 5a and 5b show the performance of an MEA using a Nafion membrane (RH 100%, H₂, 65° C.).

FIG. 6 shows the change in current density as a function of the number of hydrogen pumps when a hydrogen pump system is configured using one fuel cell and one or more hydrogen pumps an exemplary embodiment of the present disclosure and the voltage produced during the operation of the fuel cell is equal to the voltage required to operate the hydrogen pumps (Nafion membrane is used in the MEA).

FIG. 7 shows the amount of produced hydrogen as a function of the number of hydrogen pumps when a hydrogen pump system is configured using one fuel cell and one or more hydrogen pumps an exemplary embodiment of the present disclosure (Nafion membrane is used in the MEA).

FIG. 8 shows the ratio of total system cost to fuel cell cost as a function of the number of hydrogen pumps when a hydrogen pump system is configured using one fuel cell and one or more hydrogen pumps an exemplary embodiment of the present disclosure (Nafion membrane is used in the MEA).

FIG. 9 shows efficiency as a function of the number of hydrogen pumps when a hydrogen pump system is configured using one fuel cell and one or more hydrogen pumps an exemplary embodiment of the present disclosure (Nafion membrane is used in the MEA). In the figure, a is the ratio of hydrogen pump cost to fuel cell cost (M_{hydrogen pump}/M_{fuel cell}).

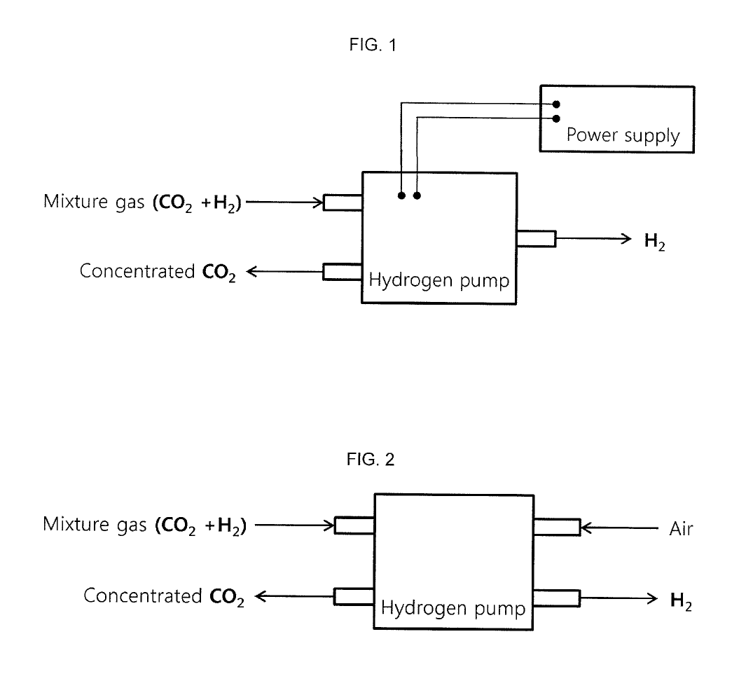

### DETAILED DESCRIPTION OF EMBODIMENTS

Hereinafter, various aspects and embodiments of the present disclosure will be described in more detail.

In an aspect, the present disclosure provides a hydrogen pump system operable without external electric power supply, comprising (i) m hydrogen pumps comprising (a₁) a first hydrogen pump, . . . , and (aₘ) an m-th hydrogen pump and (ii) n fuel cells comprising (b₁) a first fuel cell, . . . , and (bₙ) an n-th fuel cell.

(a₁) The first hydrogen pump comprises (a₁-1) a first hydrogen pump membrane electrode assembly, (a₁-2) a first hydrogen pump hydrogen supplier disposed at one side of the first hydrogen pump membrane electrode assembly, (a₁-3) a first hydrogen pump residual gas discharger, and (a₁-4) a first hydrogen pump hydrogen discharger disposed at the other side of the first hydrogen pump membrane electrode assembly; . . . ; and (aₘ) the m-th hydrogen pump comprises (aₘ-1) an m-th hydrogen pump membrane electrode assembly, (aₘ-2) an m-th hydrogen pump hydrogen supplier disposed at one side of the m-th hydrogen pump membrane electrode assembly, (aₘ-3) an m-th hydrogen pump residual gas discharger, and (aₘ-4) an m-th hydrogen pump hydrogen discharger disposed at the other side of the m-th hydrogen pump membrane electrode assembly.

(b₁) The first fuel cell comprises (b₁-1) a first fuel cell membrane electrode assembly, (b₁-2) a first fuel cell hydrogen supplier disposed at one side of the first fuel cell membrane electrode assembly, (b₁-3) a first fuel cell fuel gas supplier disposed at the other side of the first fuel cell membrane electrode assembly, and (b₁-4) a first fuel cell water discharger; . . . ; and (bₙ) the n-th fuel cell comprises (bₙ-1) an n-th fuel cell membrane electrode assembly, (bₙ-2) an n-th fuel cell hydrogen supplier disposed at one side of the n-th fuel cell membrane electrode assembly, (bₙ-3) an n-th fuel cell fuel gas supplier disposed at the other side of the n-th fuel cell membrane electrode assembly, and (bₙ-4) an n-th fuel cell water discharger.

The hydrogen pump system operable without external electric power supply comprises m+n−1 current collectors allowing transport of electrons between the m hydrogen pumps and the n fuel cells, and a first end plate and a second end plate positioned at the top and the bottom, respectively, of a stack constituting the hydrogen pump system operable without external electric power supply; and the first end plate and the second end plate are electrically connected with each other.

The gas supplied by (a₁-2) the first hydrogen pump hydrogen supplier, and (aₘ-2) the m-th hydrogen pump hydrogen supplier comprises hydrogen and at least one another gas; and the gas discharged from (a₁-3) the first hydrogen pump residual gas discharger, . . . , and (aₘ-3) the m-th hydrogen pump residual gas discharger comprises the at least one another gas.

The hydrogen content in the gas supplied by (a₁-2) the first hydrogen pump hydrogen supplier is higher than the hydrogen content in the gas discharged from (a₁-3) the first hydrogen pump residual gas discharger and is lower than the hydrogen content in the gas discharged from (a₁-4) the first hydrogen pump hydrogen discharger; . . . ; and the hydrogen content in the gas supplied by (aₘ-2) the m-th hydrogen pump hydrogen supplier is higher than the hydrogen content in the gas discharged from (aₘ-3) the m-th hydrogen pump residual gas discharger and is lower than the hydrogen content in the gas discharged from (aₘ-4) the m-th hydrogen pump hydrogen discharger. As used herein, “hydrogen content” in a gas means molar ratio of hydrogen to the gas.

m is an integer equal to or greater than 1, and n is an integer equal to or greater than 1.

At least one fuel cell hydrogen supplier of the n fuel cell hydrogen suppliers receives hydrogen discharged from one or more hydrogen pump hydrogen discharger selected from (a₁-4) the first hydrogen pump hydrogen discharger, . . . , and (aₘ-4) the m-th hydrogen pump hydrogen discharger.

Whereas the existing hydrogen pump system is commonly operated by an external power supply, the hydrogen pump system operable without external electric power supply according to various embodiments of the present disclosure can be operated without external electric power supply. Of course, an external electric power supply may be added if necessary for example, to increase production of hydrogen. That is to say, the “hydrogen pump system operable without external electric power supply” according to the present disclosure means one that can produce high-purity hydrogen without an additional external electric power supply, not just one that does not have an external power supply.

The hydrogen pump system operable without external electric power supply of the present disclosure comprises m hydrogen pumps and n fuel cells. Some of the fuel cells produce electricity by receiving concentrated hydrogen from the hydrogen pump, and the produced electricity is used to operate the hydrogen pump.

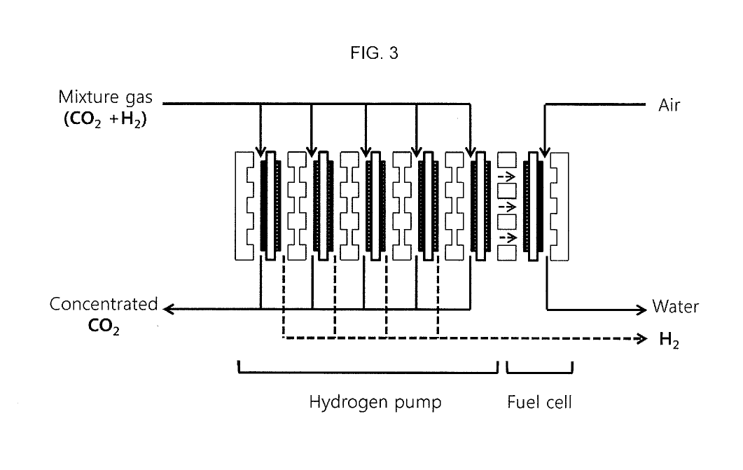

For example, the hydrogen pump system operable without external electric power supply of the present disclosure may comprise five hydrogen pumps and one fuel cell as shown in FIG. 3. Each of the hydrogen pump and the fuel cell comprises a membrane electrode assembly comprising an electrolyte membrane and an anode layer and a cathode layer, the layers positioned at the top and the bottom, respectively, of the electrolyte membrane. Also, a current collector allowing transport of electrons may be disposed between the hydrogen pump and the fuel cell.

In this case, as exemplarily illustrated in FIG. 3, hydrogen supplied by the first hydrogen pump hydrogen supplier is separated into a proton and an electron at the anode at one side of the first hydrogen pump membrane electrode assembly. The electron is transported to the fuel cell cathode after passing through the fuel cell side end plate via the hydrogen pump side end plate and the external circuit and reacts with proton passing through the fuel cell membrane electrode assembly and oxygen supplied from the fuel cell fuel gas supplier to produce water.

Meanwhile, the proton passes through the first hydrogen pump membrane electrode assembly and combines with the electron, which was separated at the second hydrogen pump anode and transported through the current collector between the first hydrogen pump and the second hydrogen pump, at the cathode at another side of the first hydrogen pump membrane electrode assembly to form hydrogen. Thus formed hydrogen gas is discharged through the first hydrogen pump hydrogen discharger at the another side of the first hydrogen pump membrane electrode assembly.

From the mixture gas supplied by the first hydrogen pump hydrogen supplier, the residual gas excluding proton is discharged by the first hydrogen pump residual gas discharger. Hydrogen gas remaining unconverted to proton may be included in the residual gas. Also, if the supplied hydrogen gas is completely converted to proton, no hydrogen may be included in the residual gas.

In an exemplary embodiment of the present disclosure, m is an integer equal to or greater than 1, and n is an integer equal to or greater than 1 and less than m. In this case, the n fuel cell hydrogen suppliers receive hydrogen discharged from n hydrogen pump hydrogen dischargers selected from (a₁-4) the first hydrogen pump hydrogen discharger, . . . , and (aₘ-4) the m-th hydrogen pump hydrogen discharger.

That is to say, in accordance with this embodiment, the number of the hydrogen pumps is larger than the number of the fuel cells, and, in this case, the fuel cells may be operated by receiving high-purity hydrogen gas concentrated by the hydrogen pumps.

In another exemplary embodiment of the present disclosure, m is an integer equal to or greater than 1, and n is an integer greater than m. In this case, the hydrogen pump system operable without external electric power supply comprises n−m external fuel cell hydrogen suppliers supplying hydrogen from outside to the fuel cell. m fuel cell hydrogen suppliers selected from the n fuel cell hydrogen suppliers receive hydrogen discharged from (a₁-4) the first hydrogen pump hydrogen discharger, . . . , and (aₘ-4) the m-th hydrogen pump hydrogen discharger, and the remaining n−m fuel cell hydrogen suppliers receive hydrogen from the n−m external fuel cell hydrogen suppliers.

That is to say, in accordance with this embodiment, the number of the hydrogen pumps is smaller than the number of the fuel cells, and, in this case, the fuel cells corresponding to the number of the hydrogen pumps may be operated by receiving high-purity hydrogen gas concentrated by the hydrogen pumps and the remaining fuel cells may be operated by receiving hydrogen from outside. In this case, the hydrogen supplied from outside may be high-purity hydrogen gas commonly used for a fuel cell. In another exemplary embodiment of the present disclosure, the m hydrogen pumps and the n fuel cells are connected in series in the order of the first hydrogen pump, . . . , the m-th hydrogen pump, the first fuel cell, . . . and the n-th fuel cell. And, the current collector disposed between the m-th hydrogen pump and the first fuel cell may be a porous current collector allowing transport of hydrogen and electrons.

That is to say, in accordance with this embodiment, the m hydrogen pumps and the n fuel cells may be connected in series in the order of the first hydrogen pump, . . . , the m-th hydrogen pump, the first fuel cell, . . . and the n-th fuel cell. And, a porous current collector may be disposed between the m-th hydrogen pump and the first fuel cell to allow transport of hydrogen and electrons between the neighboring hydrogen pumps or fuel cells. Through this design, production cost can be decreased by reducing the volume of the system. Also, system durability can be improved through the simplified configuration.

More specifically, the m hydrogen pumps and the n fuel cells may be connected in series in the order of the first hydrogen pump, . . . , the m-th hydrogen pump, the first fuel cell, . . . and the n-th fuel cell as an integrated stack; and the current collector disposed between the m-th hydrogen pump and the first fuel cell may be a porous current collector allowing transport of hydrogen and electrons. Use of the integrated stack not only reduces the system volume but also significantly improves the durability.

In another exemplary embodiment of the present disclosure, m is an integer from 2 to 500, and n is an integer from 1 to 200. That is to say, the number of the hydrogen pumps may be 2-500, specifically 3-300, more specifically 5-150, and the number of the fuel cells may be 1-200, specifically 1-100, more specifically 1-50.

In another exemplary embodiment of the present disclosure, the hydrogen pump system operable without external electric power supply may further comprise an external DC power supply.

The voltage produced by the fuel cell and the voltage consumed by the hydrogen pump in the hydrogen pump systems operable without external electric power supply according to various embodiments of the present disclosure are as follows. However, the following equations are provided only as examples and other general functions may also be used.

1 hydrogen pump: V_{HP}=cl

m hydrogen pumps: mV_{HP}=mcl

1 fuel cell: V_{FC}=a+bl

n fuel cells: nV_{FC}=na+nbl

(V_{HP} is the voltage required to operate one hydrogen pump, V_{FC} is the voltage produced by one fuel cell, l is current, m is the number of hydrogen pumps, n is the number of fuel cells, and a, b and c are system-dependent constants.)

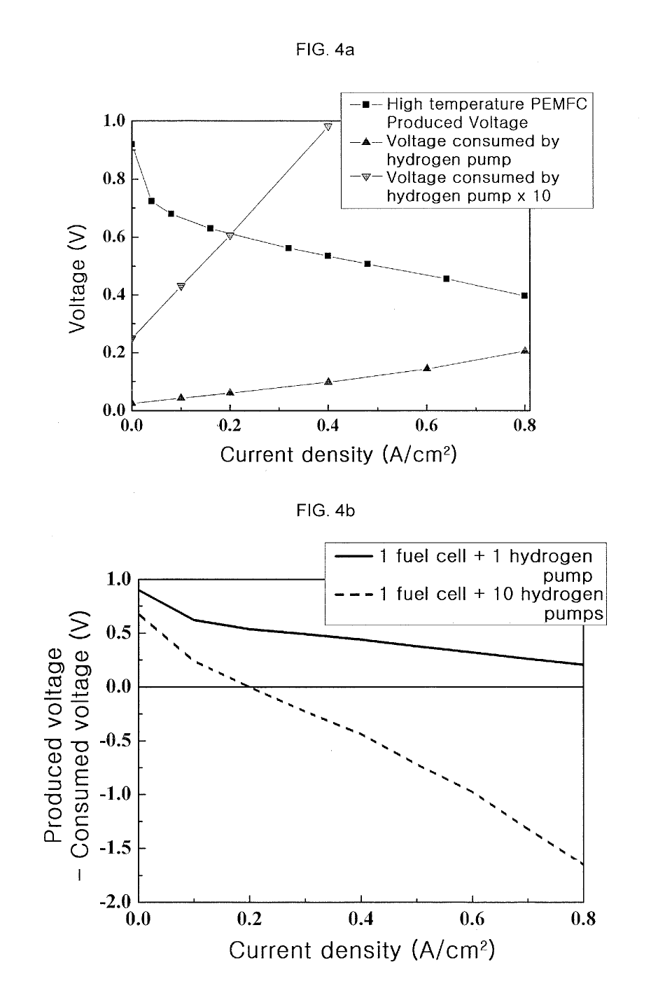

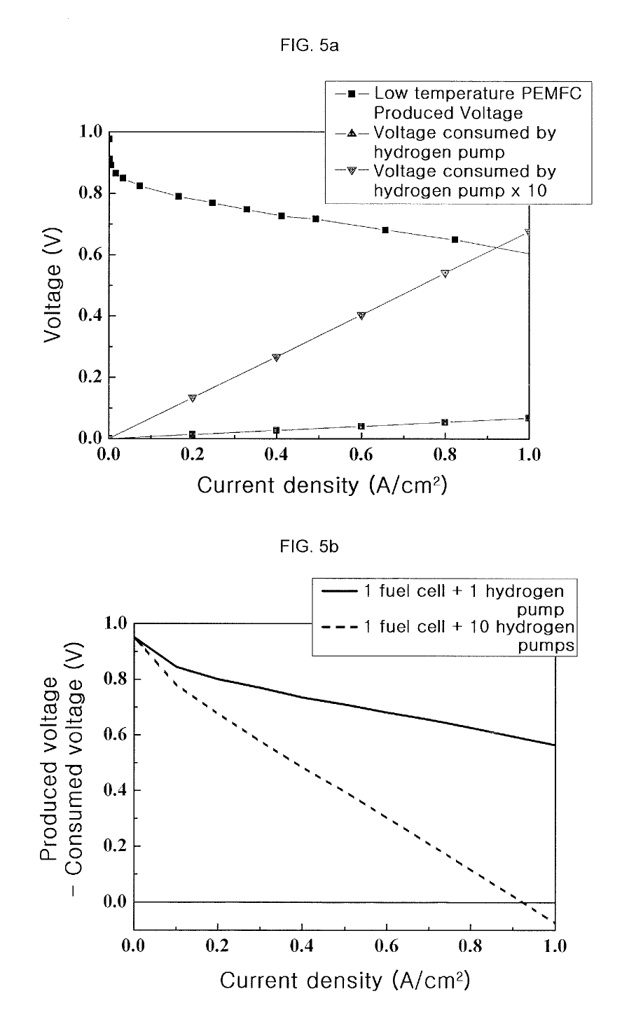

Suppose that all the voltage produced by the fuel cells is used to operate the hydrogen pumps without an external DC power supply, current density during the operation is determined as follows. FIGS. 4a and 5a are I-V curves for a system using one fuel cell. If 10 hydrogen pumps are used, current density is determined as 0.2 A/cm² and 0.9 A/cm² from FIGS. 4a and 5a, respectively.

mV_{HP}=nV_{FC}

mcl=na+nbl

I=na/(mc−nb)

Otherwise, if an external DC power supply is used and only part of the voltage produced by the fuel cells is used to operate the hydrogen pumps, current density during the operation may be determined as follows.

mV_{HP}+V_{R}=nV_{FC}Vₑₓₜ

mcl+V_{R}=na+nbl+Vₑₓₜ

I=(Vₑₓₜ−V_{R}+na)/(mc−nb)

(Vₑₓₜ is the voltage from the added external DC power supply, and V_{R} is the voltage consumed by the hydrogen pumps in the system.)

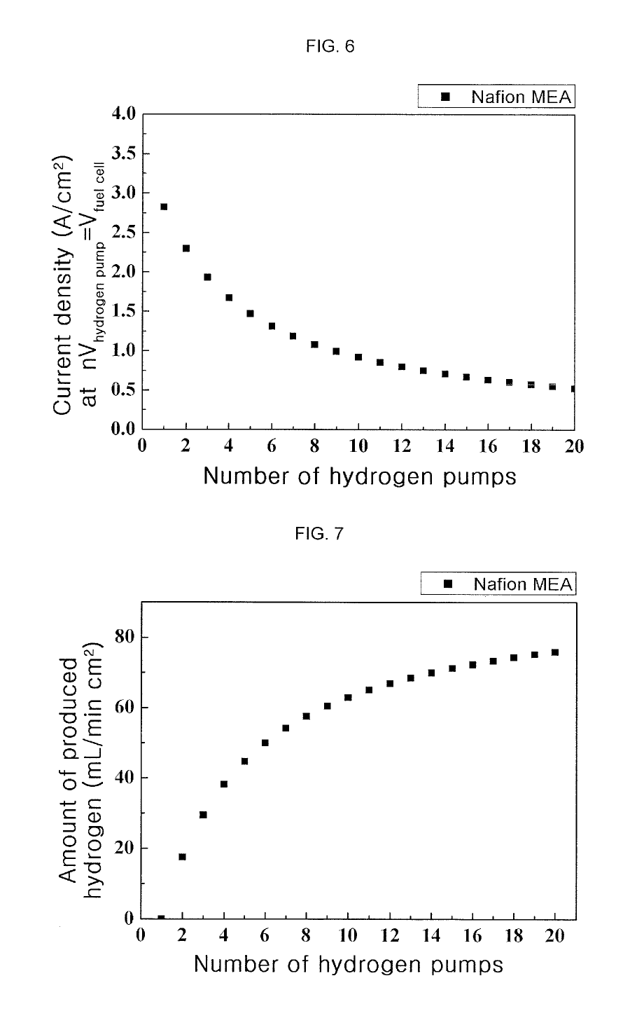

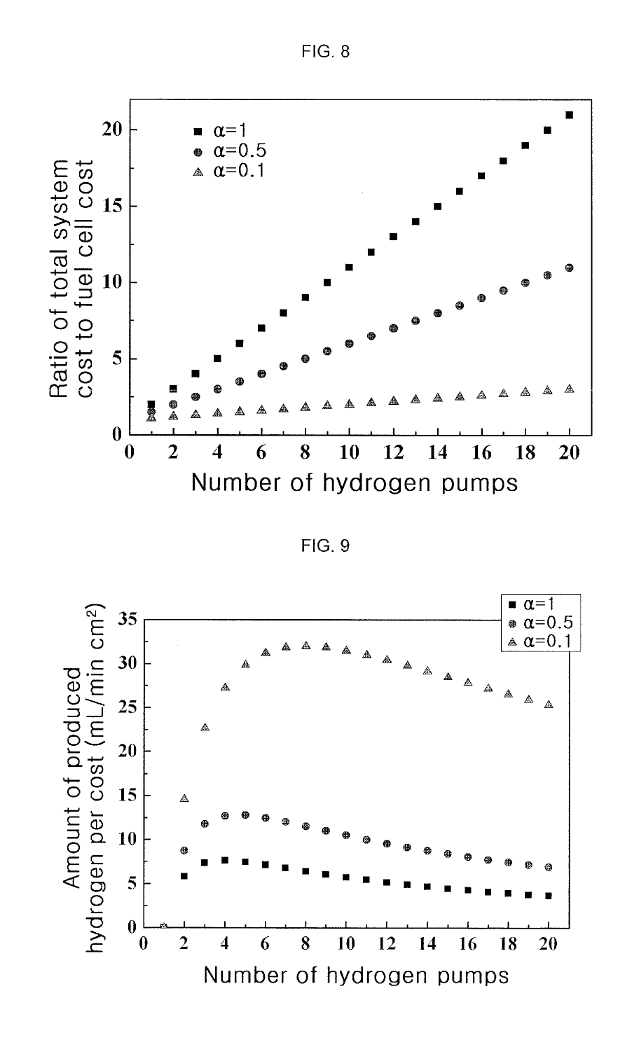

When one fuel cell is used, (i) the current density, (ii) the amount of produced hydrogen and (iii) the ratio of total system cost to fuel cell cost as the number of hydrogen pumps is increased are as shown in FIGS. 6-8. Accordingly, a system can be designed with the number of hydrogen pumps giving the maximum amount of produced hydrogen per cost using the curve shown in FIG. 9.

While the present disclosure has been described with respect to the specific embodiments, it will be apparent to those skilled in the art that various changes and modifications may be made without departing from the spirit and scope of the disclosure as defined in the following claims.

1. A hydrogen pump system operable without external electric power supply, comprising (i) m hydrogen pumps comprising (a₁) a first hydrogen pump, . . . , and (aₘ) an m-th hydrogen pump and (ii) n fuel cells comprising (b₁) a first fuel cell, . . . , and (bₙ) an n-th fuel cell,
wherein
(a₁) the first hydrogen pump comprises (a₁-1) a first hydrogen pump membrane electrode assembly, (a₁-2) a first hydrogen pump hydrogen supplier disposed at one side of the first hydrogen pump membrane electrode assembly, (a₁-3) a first hydrogen pump residual gas discharger, and (a₁-4) a first hydrogen pump hydrogen discharger disposed at the other side of the first hydrogen pump membrane electrode assembly; . . . ; and (aₘ) the m-th hydrogen pump comprises (aₘ-1) an m-th hydrogen pump membrane electrode assembly, (aₘ-2) an m-th hydrogen pump hydrogen supplier disposed at one side of the m-th hydrogen pump membrane electrode assembly, (aₘ-3) an m-th hydrogen pump residual gas discharger, and (aₘ-4) an m-th hydrogen pump hydrogen discharger disposed at the other side of the m-th hydrogen pump membrane electrode assembly;
(b₁) the first fuel cell comprises (b₁-1) a first fuel cell membrane electrode assembly, (b₁-2) a first fuel cell hydrogen supplier disposed at one side of the first fuel cell membrane electrode assembly, (b₁-3) a first fuel cell fuel gas supplier disposed at the other side of the first fuel cell membrane electrode assembly, and (b₁-4) a first fuel cell water discharger; . . . ; and (bₙ) the n-th fuel cell comprises (bₙ-1) an n-th fuel cell membrane electrode assembly, (bₙ-2) an n-th fuel cell hydrogen supplier disposed at one side of the n-th fuel cell membrane electrode assembly, (bₙ-3) an n-th fuel cell fuel gas supplier disposed at the other side of the n-th fuel cell membrane electrode assembly, and (bₙ-4) an n-th fuel cell water discharger;
the hydrogen pump system operable without external electric power supply comprises m+n−1 current collectors allowing transport of electrons between the m hydrogen pumps and the n fuel cells, and a first end plate and a second end plate positioned at the top and the bottom, respectively, of a stack constituting the hydrogen pump system operable without external electric power supply; and the first end plate and the second end plate are electrically connected with each other by an external electrical circuit;
the gas supplied by (a₁-2) the first hydrogen pump hydrogen supplier, . . . , and (aₘ-2) the m-th hydrogen pump hydrogen supplier comprises hydrogen and at least one another gas; and the gas discharged from (a₁-3) the first hydrogen pump residual gas discharger, . . . , and (aₘ-3) the m-th hydrogen pump residual gas discharger comprises the at least one another gas;
the hydrogen content in the gas supplied by (a₁-2) the first hydrogen pump hydrogen supplier is higher than the hydrogen content in the gas discharged from (a₁-3) the first hydrogen pump residual gas discharger and is lower than the hydrogen content in the gas discharged from (a₁-4) the first hydrogen pump hydrogen discharger; . . . ; and
the hydrogen content in the gas supplied by (aₘ-2) the m-th hydrogen pump hydrogen supplier is higher than the hydrogen content in the gas discharged from (aₘ-3) the m-th hydrogen pump residual gas discharger and is lower than the hydrogen content in the gas discharged from (aₘ-4) the m-th hydrogen pump hydrogen discharger;
m is an integer equal to or greater than 1, and n is an integer equal to or greater than 1; and
at least one fuel cell hydrogen supplier of the n fuel cell hydrogen suppliers receives hydrogen discharged from one or more hydrogen pump hydrogen discharger selected from (a₁-4) the first hydrogen pump hydrogen discharger, . . . , and (aₘ-4) the m-th hydrogen pump hydrogen discharger.

2. The hydrogen pump system operable without external electric power supply according to claim 1,
wherein
m is an integer equal to or greater than 1, and n is an integer equal to or greater than 1 and less than m; and
the n fuel cell hydrogen suppliers receive hydrogen discharged from n hydrogen pump hydrogen dischargers selected from (a₁-4) the first hydrogen pump hydrogen discharger, . . . , and (aₘ-4) the m-th hydrogen pump hydrogen discharger.

3. The hydrogen pump system operable without external electric power supply according to claim 1,
wherein
m is an integer equal to or greater than 1, and n is an integer greater than m;
the hydrogen pump system operable without external electric power supply comprises n−m external fuel cell hydrogen suppliers supplying hydrogen from outside to the fuel cell;
m fuel cell hydrogen suppliers selected from the n fuel cell hydrogen suppliers receive hydrogen discharged from (a₁-4) the first hydrogen pump hydrogen discharger, . . . , and (aₘ-4) the m-th hydrogen pump hydrogen discharger; and
the remaining n−m fuel cell hydrogen suppliers receive hydrogen from the n−m external fuel cell hydrogen suppliers.

4. The hydrogen pump system operable without external electric power supply according to claim 1,
wherein
the m hydrogen pumps and the n fuel cells are connected in series in the order of the first hydrogen pump, . . . , the m-th hydrogen pump, the first fuel cell, . . . and the n-th fuel cell; and
the current collector disposed between the m-th hydrogen pump and the first fuel cell is a porous current collector allowing transport of hydrogen and electrons.

5. The hydrogen pump system operable without external electric power supply according to claim 1,
wherein
the m hydrogen pumps and the n fuel cells are connected in series in the order of the first hydrogen pump, . . . , the m-th hydrogen pump, the first fuel cell, . . . and the n-th fuel cell as an integrated stack; and
the current collector disposed between the m-th hydrogen pump and the first fuel cell is a porous current collector allowing transport of hydrogen and electrons.

6. The hydrogen pump system operable without external electric power supply according to claim 2, wherein m is an integer from 2 to 500, and n is an integer from 1 to 200.

7. The hydrogen pump system operable without external electric power supply according to claim 1, wherein the hydrogen pump system operable without external electric power supply further comprises an external DC power supply.

8. A hydrogen pump system operable without external electric power supply, comprising (i) m hydrogen pumps comprising (a₁) a first hydrogen pump, . . . , and (aₘ) an m-th hydrogen pump and (ii) n fuel cells comprising (b₁) a first fuel cell, . . . , and (bₙ) an n-th fuel cell,
wherein
(a₁) the first hydrogen pump comprises (a₁-1) a first hydrogen pump membrane electrode assembly, (a₁-2) a first hydrogen pump hydrogen supplier disposed at one side of the first hydrogen pump membrane electrode assembly, (a₁-3) a first hydrogen pump residual gas discharger, and (a₁-4) a first hydrogen pump hydrogen discharger disposed at the other side of the first hydrogen pump membrane electrode assembly; . . . ; and (aₘ) the m-th hydrogen pump comprises (aₘ-1) an m-th hydrogen pump membrane electrode assembly, (aₘ-2) an m-th hydrogen pump hydrogen supplier disposed at one side of the m-th hydrogen pump membrane electrode assembly, (aₘ-3) an m-th hydrogen pump residual gas discharger, and (aₘ-4) an m-th hydrogen pump hydrogen discharger disposed at the other side of the m-th hydrogen pump membrane electrode assembly;
(b₁) the first fuel cell comprises (b₁-1) a first fuel cell membrane electrode assembly, (b₁-2) a first fuel cell hydrogen supplier disposed at one side of the first fuel cell membrane electrode assembly, (b₁-3) a first fuel cell fuel gas supplier disposed at the other side of the first fuel cell membrane electrode assembly, and (b₁-4) a first fuel cell water discharger; . . . ; and (bₙ) the n-th fuel cell comprises (bₙ-1) an n-th fuel cell membrane electrode assembly, (bₙ-2) an n-th fuel cell hydrogen supplier disposed at one side of the n-th fuel cell membrane electrode assembly, (bₙ-3) an n-th fuel cell fuel gas supplier disposed at the other side of the n-th fuel cell membrane electrode assembly, and (bₙ-4) an n-th fuel cell water discharger;
the hydrogen pump system operable without external electric power supply comprises m+n−k−1 current collectors allowing transport of electrons between the m hydrogen pumps and the n fuel cells, k electrical cables, and a first end plate and a second end plate positioned at the top and the bottom, respectively, of a stack constituting the hydrogen pump system operable without external electric power supply; the m hydrogen pumps and the n fuel cells are electrically connected via the m+n−k−1 current collectors and the k electrical cables; and the first end plate and the second end plate are electrically connected with each other by an external electrical circuit;
the gas supplied by (a₁-2) the first hydrogen pump hydrogen supplier, . . . , and (aₙ-2) the m-th hydrogen pump hydrogen supplier comprises hydrogen and at least one another gas; and the gas discharged from (a₁-3) the first hydrogen pump residual gas discharger, . . . , and (aₘ-3) the m-th hydrogen pump residual gas discharger comprises the at least one another gas;
the hydrogen content in the gas supplied by (a₁-2) the first hydrogen pump hydrogen supplier is higher than the hydrogen content in the gas discharged from (a₁-3) the first hydrogen pump residual gas discharger and is lower than the hydrogen content in the gas discharged from (a₁-4) the first hydrogen pump hydrogen discharger; . . . ; and
the hydrogen content in the gas supplied by (aₘ-2) the m-th hydrogen pump hydrogen supplier is higher than the hydrogen content in the gas discharged from (aₘ-3) the m-th hydrogen pump residual gas discharger and is lower than the hydrogen content in the gas discharged from (aₘ-4) the m-th hydrogen pump hydrogen discharger;
m is an integer of 1-500, n is an integer of 1-500, and k is an integer 0-10; and
at least one fuel cell hydrogen supplier of the n fuel cell hydrogen suppliers receives hydrogen discharged from one or more hydrogen pump hydrogen discharger selected from (a₁-4) the first hydrogen pump hydrogen discharger, . . . , and (aₘ-4) the m-th hydrogen pump hydrogen discharger.
